(19) United States
(12) Patent Application Publication
(10) Pub. No.: US 2006/0178168 A1
(43) Pub. Date: Aug. 10, 2006

(54) Methods and apparatus for alerting a wireless network administrator to the location or status of a wireless device

(76) Inventor: Peter Roach, Atlanta, GA (US)

Correspondence Address: PETER O. ROACH JR., 1150 IVES CT., ATLANTA, GA, 30319, US

(21) Appl. No.: 11/052,120

(22) Filed: Feb. 7, 2005

(51) Int. Cl. H04M 1/00

(52) U.S. Cl. 455/567; 455/550.1

(57) ABSTRACT

Methods and apparatus are provided for alerting a user, technician, or network administrator to the status or location of a wireless device.

### TECHNICAL FIELD

The present invention relates generally to a wired or wireless communications network and more particularly to the use of radio communications networks in a dwelling, commercial building, campus environment, tunnels and/or neighborhoods.

### BACKGROUND OF THE INVENTION

In recent years, wireless communications networks have begun to penetrate into homes, office buildings, business parks, and neighborhoods. Most of these wireless networks are private networks serving a home, single building, or campus. In order to meet current government rules regulating the use of radio spectrum, a low signal transmit level is often used in these types of environments. This lower transmit level allows the signal to be effectively limited to the desired area by using walls, furniture, other obstructions, or even free space to attenuate the signal and contain it. While a low transmit level works well to contain the signal, it can also have unintended consensuses of allowing gaps in the coverage area where signals may be desired.

As businesses and commercial spaces deploy large wireless local area networks (WLAN) they have begun to realize the complexity of these networks tends to grow exponentially as the coverage area grows. This is mainly due to the number of radio transmitters or channels needed to cover an enterprise space. In many wireless LAN technologies there are a limited number of radio channels available from any individual radio transmitter, base station, or access point. This limit is caused primarily by the availability of non-overlapping or non-interfering radio channels. Typically the number of channels is limited by bandwidth, regulations, or interference. This limit is further exacerbated by the need to provide spacing between radios on the same or adjacent channels in order to minimize the interference between the radios. In a wireless system this is typically handled through managing the reuse of spectrum between radios, base stations, transmitters, access points, or other similar devices (hereafter referred to as Radio Infrastructure Device or RID) within the desired coverage area. This limitation of available spectrum along with the need to physically separate the radios on the same or adjacent channels require a large number of diverse locations to be deployed within a WLAN to ensure capacity is available for the desired applications.

Another rationale for multiple diverse RIDs at multiple diverse locations when deploying a WLAN is the limitations on transmit power for most WLAN technologies. These limitations are usually due to governmental regulations, safety of the users, reduction of potential interference with other radios or WLANs, to maximize reuse of spectrum, or to maximize traffic carrying capacity of the overall WLAN. While this low power effectively limits the radius on an individual radio's coverage area, it also creates more shadows or dead spots in WLAN coverage. In order to obtain acceptable coverage in the desired footprint, a WLAN administrator usually needs to install RIDs at a number of diverse points within the network.

For the above mentioned reasons a WLAN usually requires a number of RIDs to cover the intended area, and as the area is expanded this causes a corresponding exponential increase in RIDs. This is one of the major drivers in the exponential increase in complexity of a WLAN as it is expanded to cover a greater area.

In order to effectively handle the complexity of the WLANs, many in the industry have begun to allow these devices to self configure, register on the network, use wireless as a backhaul method for RID, and determines the most efficient path to route messages. This type of networking is usually referred to as a ‘Mesh’ networking. Mesh networking allows a network administrator to easily add a device to the network with little or no programming. Once a Mesh device is added to the network it typically registers on the network, automatically configures itself, and works out the most efficient method of routing messages using preprogrammed rules. Typically a mesh network is much easier to administer and will self-heal in the event of failure(s). This type of networking removes a great deal of complexity from the process of building and administering a WLAN network.

While Mesh networking allows a device to be easily added to a WLAN network, there is still the problem of providing backhaul and power for a RID. The backhaul issue has been addressed by the others in the industry by using wireless to backhaul the signals to the wired network; however, this can have an unintended consequence of actually increasing the cost and difficulty of installing a RID into a WLAN. When a non-mesh network RID is installed it usually requires both a power and data connection—usually Ethernet. Traditionally, this has required the installation of both a power and a data cable to enable an RID to function. This problem has been addressed by the use of power over Ethernet (PoE) that permits both direct current power as well as data to be carried over a traditional Ethernet cable. Due to the equipment required to inject and remove the power from the Ethernet cable, this type of installation is typically more expensive than a straight Ethernet installation; however, in most cases the PoE is more cost efficient than installing both an Ethernet connection and a power line or even a power line alone. Installing a power line for an application, such as wireless nodes in an enterprise or commercial space, can require:
Installation by a qualified electrician
Special plenum rated electrical cable
Secure mounting to existing structures
Unique home run circuit to the electrical closet for uninterruptible power source,

Since PoE is a lower voltage and typically does not draw a high electrical current, most building codes treat these cables in the same manner as standard Ethernet cable. This greatly reduces the cost and complexity of supplying power to a WLAN device.

Usually a mesh type wireless network utilizes a wireless link to establish the backhaul between the nodes in the network. While the mesh-network eliminates the need for the hardwired data connection, in eliminating the PoE it will then requires a separate power circuit installed by an electrician. As stated above, the requirement to utilize a qualified electrician, as well as the increased cost of supplies, can substantially increase the overall cost of installing a wireless network.

Prior art (PCT/US2004/016099—filed May 21, 2004 and PCT/JUS/2004/015955—filed May 21, 2004) by Roach teaches how to mount and power a WLAN device by utilize the connection between a florescent lamp and the lighting fixture and are hereby included in this disclosure by reference. These disclosures in conjunction with the Mesh networking techniques described allow a RID to be easily and quickly installed into a WLAN. These disclosures and techniques also allow a RID to be easily moved between locations in a WLAN.

With this ease of installation and relocation a WLAN administrator is likely to install or reconfigure the WLAN RIDs often to respond to environmental factors, capacity requirements, interference problems, radio coverage requirements, expansion plans, or other similar issues. As the WLAN administrator gains the ability to easily install or rapidly move the RID, they are likely to lose track of the exact location or status of the device. This problem may be amplified when a technician is required to service a device. It may be difficult to locate an individual device or a group of devices with common characteristics; e.g., certain version of software/hardware, transmit frequencies, programming characteristics, or similar issues. It may also be extremely difficult to determine the name, status, alarm state, or other similar information about a device while away from the monitoring consol.

Accordingly, there is a need to overcome the limitations of the prior art by adapting a wireless network component to enable it to provide a signal to the network administrator, technician, or operator when they are away from their consol and in the environment where the wireless network component is located.

### BRIEF DESCRIPTION OF THE DRAWINGS

FIG. 1—Wireless device with an audible alert

FIG. 2—Wireless device with an alternative audible alert

FIG. 3—Wireless device with a visual alert

FIG. 4—Logic flow for audible alert message

### DETAILED DESCRIPTION OF EXEMPLARY EMBODIMENTS

The present invention solves the problems of the prior art by providing an apparatus and method for visually or audibly locating a WLAN device or determining the status of the device while working on the device, in the work space where the WLAN device is mounted, or the environment where the WLAN device is located. Since the prior art describes a method of easily relocating these types of devices, they may have a tendency to become misplaced or a technician, working in close proximity to multiple devices may confuse their identies.

The first method and apparatus disclosed to solve the problem is to place an audible indicator on the device that can be triggered in response to a stimulus that will assist in locating or trouble shooting the device. While those skilled in the art using this disclosure will be able to envision other implementations of this invention, the preferred method of implementing the audible alert is to place a speaker on the unit along with the necessary circuitry and logic needed to play an electronic file representing a sound or stream of encoded audio. This will enable a network administrator remotely located at a control consol connected to the network to direct a specific or group of RIDs to play a sound or announcement, such as, “If you hear this announcement please call corporate support on [extension number] to report a malfunctioning radio” or similar announcement. This functionality will also allow a technician working in proximity of the RID to use a laptop terminal, personal digital assistant, or similar device equipped with a wireless connection to instruct, via the wireless connection, the WLAN RID to play a sound, tone, or recording such as “I am here” in order to assist in locating a specific device. Using this disclosure one skilled in the art can see how there are several other methods to allow users, technicians, or WLAN administrators to play sound files or streaming a real-time announcement to the RID for general business announcements, emergencies, trouble shooting, locating a device with particular programming or other similar functions.

Since multiple different RIDs are connected to a network at a given time a network administrator or technician can use the audio announcement capability of the RIDs to instruct multiple units to play the same or similar announcements. This functionality can aid in troubleshooting the WLAN radio network or locating similar/dissimilar RIDs. For example the technician looking for RIDs with certain hardware or software profiles can signal the units with the desired profile to begin playing a sound or tone. This will enable the technician to audibly locate the devices or groups of devices. This audible location functionality can also be used in conjunction with a RID naming convention to allow RIDs belonging to a group to be audibly identified. For example RIDs on the certain floor of a facility could all have a naming convention “WWWFFFDDUUUU” where “W” is the WLAN identifier, F is the floor number, “D” is the direction (e.g., N—for North, NE—for northeast, etc.), and “U” is a unique identifier. The WLAN administrator or technician could then send a trigger message requesting all of the units on a specified floor to report. The RID would then perform a pattern match using the trigger message sent by the WLAN administrator to its unique preprogrammed name to determine if the message was directed to the individual unit. This would allow the WLAN administrator or technician to locate all of the devices in a group at one time. More importantly it would also allow them to easily locate exceptions to a given constraint by merely listing for the different tone.

In order to achieve the desired flexibility for this system, the messaging used to trigger an audible alert from the RID(s) would instruct the RIDs to perform a pattern match on the name and, in addition, allow for wild card characters or ranges to be used in the trigger message. For example, using the naming convention outlined above, a message formatted similar to “WW*1*DDUUUU”, where 1 indicates the most significant digit in the floor number, would cause the RIDs on floors 10 through 19 to respond to the message. This can be used as a modified public announcement system, for troubleshooting, normal maintenance, or installation.

In addition to the pattern matching with the RID's name, it is envisioned the message could be used to trigger a response from units with a specific status, programming, version number, software load, or other similar item. For example the WLAN administrator or technician may wish to locate all of the RIDs on a particular frequency, RIDs utilizing a common hub for wireless backhaul, or any number of other common elements. It is envisioned the RIDs would perform a pattern match for almost all programmable or static variables in RID. These can include traffic statistics, infrastructure supporting the RID (e.g., computer server, validation server, router, etc. . . . ). With this capability a technician looking to add an additional traffic carrying capacity to the network could easily determine historical traffic load by having RIDs fitting a certain historical traffic pattern play an audible tone. The technician could even instruct different RIDs to play a different tone depending on the historical or current traffic pattern experienced by the RID. These tones could go from high pitch for high traffic RIDs to low pitch for low traffic RIDs. This would enable the technician to determine where to locate a new RID by merely walking around the work space and listening to the tones.

Using this disclosure in conjunction with the prior art one skilled in the art can determine how an audible alert functionality can be utilized in other functions such as determining frequency reuse between RIDs within a WLAN or any number of other similar functions.

As the related applications from the same inventor indicate it may be desirable to locate RID units on or near the ceiling of a facility or even hanging from a florescent bulb in a lighting fixture. With this in mind the audible alert speaker should be located in a fashion to allow the sound to be directed into the area where the users or technicians are normally located. The preferred location for the speaker is on the bottom of the RID however one skilled in the art could determine a multitude of other methods to mount the audio device onto or adjacent to the RID to achieve the intent of this disclosure.

To solve the stated problem it is also desirable to have a visual display on the RID. The preferred implementation of the visual display is to attach a liquid crystal display (LCD) display to the underside of an RID. The display on the underside will allow the user, network administrator, or technician to easily see unique information of the RID without removing it from its mounting on or near the ceiling or to elevate themselves in order to view the LCD. As stated earlier, with the flexibility of installation and relocation of an RID the devices are prone to be misplaced or the location may be unsure. If a technician is dispatched to retrieve a particular device they need a convenient method to determine the name of the intended device. The visual display is intended to provide this information.

The preferred implementation is also envisioned to program the RID to display the RID name and the frequency on the LCD when in a normal state. If the RID is connected to another RID or hub site for backhaul, the display can be used to display the backhaul host name, hub name, or indicator. However, in the event of a failure the RID should be programmed to display the fault or relevant information for troubleshooting. It can also be programmed to flash the display or other similar method of gaining human attention. This alerting functionality could use both the visual and audible alerting functionality together or in a complementary manner.

Using this disclosure one skilled in the art can determine how the visual display can be used to display other information such as utilization statistics, alarms, frequency information, infrastructure information, programming information, alerting messages, or other similar items to a person in the environment with the RID. Also, one skilled in the art can see how a technician or other similar individual can use a handheld or portable computer to trigger differing responses from an RID or group of RIDs thus simplifying troubleshooting or maintenance activities on the WLAN.

The RID could also be programmed to utilize the visual display in response to a query message from the network administrator technician or other similar device or individual. This query message would instruct the RID to display the intended information and, as with a trigger message for the audible alert, the query message could contain wild cards, pattern matching, and other similar techniques to enable a comprehensive troubleshooting of the network by onsite personnel.

One skilled in the art, utilizing the information in this disclosure, can determine other methods of providing visual and audible alerts as well as other methods to trigger these alerts from a network or by communicating directly with the RID. They can also use this disclosure to determine how to utilize these techniques on other radio or network devices. It is the intention of this disclosure not to limit the use of these techniques merely to the stated RID devices but to also include any type of networking device that a technician must monitor, and is mounted in an office or public environment, with a communications path.

Based on the foregoing, it can be seen that the present invention provides methods and apparatuses for alerting a wireless network administrator to the location or status of a wireless device. Many other modifications, features and embodiments of the present invention will become evident to those of skill in the art. It should be appreciated, therefore, that many aspects of the present invention were described above by way of example only and are not intended as required or essential elements of the invention unless explicitly stated otherwise. Accordingly, it should be understood that the foregoing relates only to certain embodiments of the invention and that numerous changes may be made therein without departing from the spirit and scope of the invention as defined by the following claims. It should also be understood that the invention is not restricted to the illustrated embodiments and that various modifications can be made within the scope of the following claims.

### DETAILED DESCRIPTION OF THE DRAWINGS

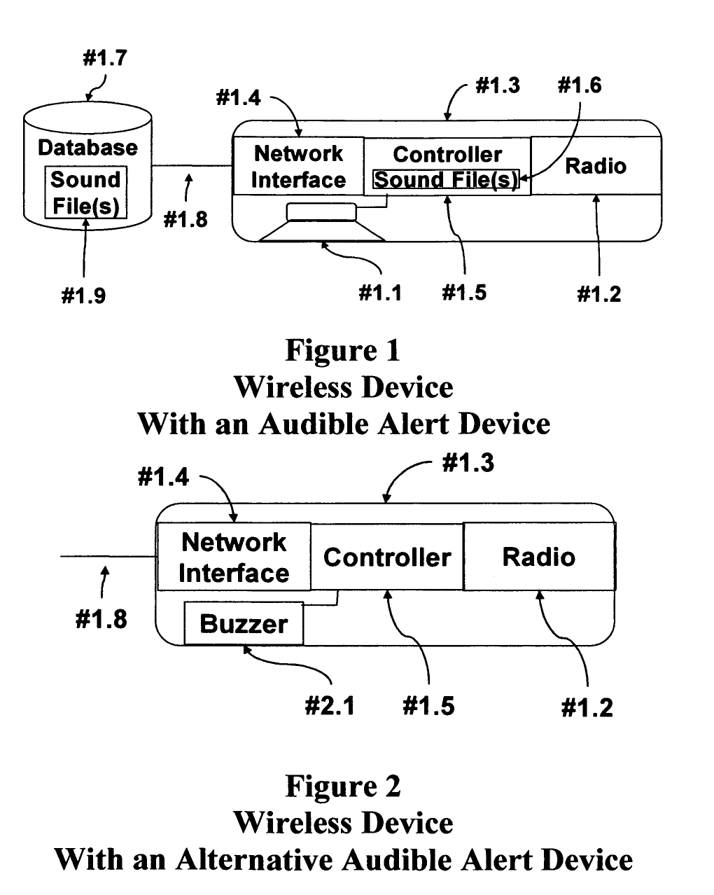

The wireless device 1.3 (FIG. 1, 2, 3) contains a network interface 1.4, a controller 1.5, and a radio 1.2. As one skilled in the art can determine these functions can be combined into a single physical device or can be separate physical devices containing these logical functions. The network interface 1.4 is designed to interface the wireless device 1.3 to the network 1.8. This interface can either be through a wired connection or wireless connection. The radio 1.2 is used to communicate with end user devices; however, it can be used to communicate with the network in order to provide backhaul capabilities for an untethered wireless device via the network 1.8. The controller 1.5 contains the logic to allow the network interface 1.4 to provide a trigger message that instructs the controller 1.5 to play a sound file(s) 1.5 or a sound file 1.9 received from the network interface 1.8 by using the speaker 1.1. The controller 1.1 can either contain the desired digitally encoded sound file 1.6 and logic for formatting and playing an audible alert message or alternatively the sound file 1.9 can be located on another device such as a data base 1.7, server, or end user device (not shown). The controller 1.5 can also trigger the speaker 1.1 to play a sound file 1.9 or 1.5 in response to detecting an abnormal operating condition of the wireless device 1.3 or surrounding wireless devices.

Alternatively as shown in FIG. 2 the speaker can be replaced with a buzzer 2.1 to achieve desired result of audible alerting a human. The buzzer 2.1 would most likely not require a sound file 1.5 or 1.9; however, the controller 1.5 could be programmed to instruct the buzzer 2.1 to play a cadence or tune to indicate individual trigger messages or abnormal conditions.

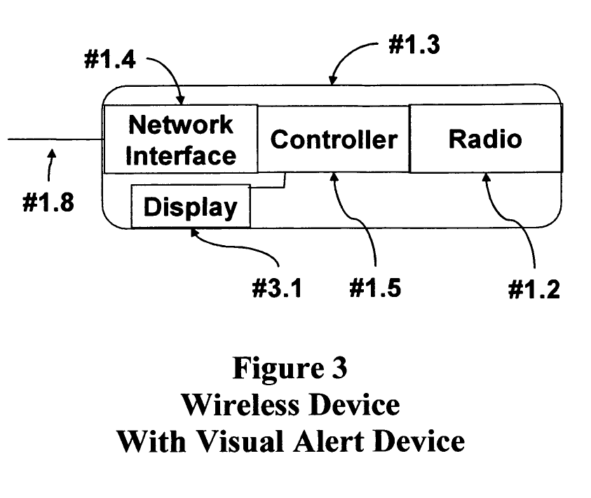

As depicted in FIG. 3, in order to for the controller 1.5 to display visual information to a human, a display 3.1 is affixed to the bottom of the wireless device 1.3. The mounting position of display 3.1 is in such a manner and a size that a human can readily view the display without the use of tools or a support device such as a ladder when the wireless device is affixed to a ceiling, light as described in the related disclosures, lighting fixture mounted in the ceiling, or merely high in the environment. The display 3.1 is of such a nature that it is facing toward the bottom of the wireless device to enable proper viewing by a human standing on the floor when the wireless device is mounted in the normal working position.

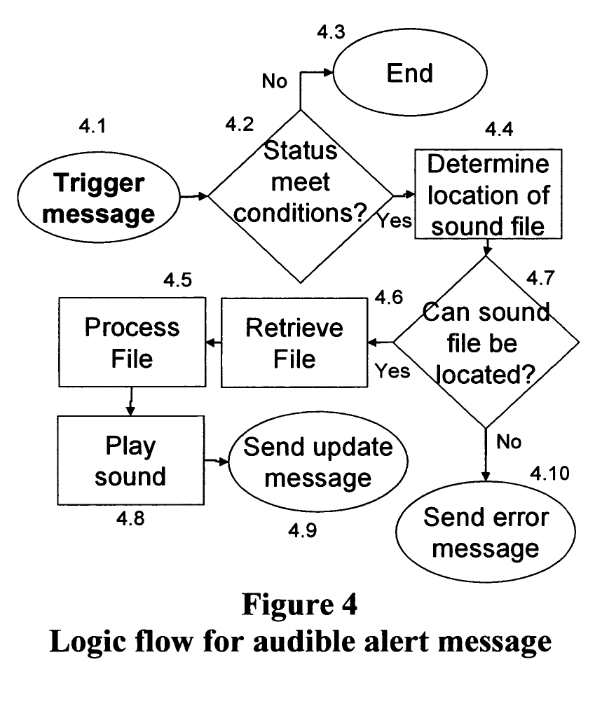

FIG. 4 illustrates the logic flow for an incoming message 4.1 to trigger an audible alert 4.9 from the wireless device. The incoming trigger message 4.1 can be from the attached wired or wireless network or from an event that occurred internally to the wireless device. Upon receiving the trigger 4.1, the logic in the wireless device would first determine if the status of the wireless device matched the conditions set forth in the trigger message 4.1—step 4.2. If the status did not meet the conditions then the process would end with no further actions taken. If the status of the wireless device met the conditions of the trigger message 4.1, the wireless device would determine the location of the sound file 4.4. The sound file could be stored locally to the wireless device or on the network. If the sound file could not be located the wireless device would send an error message 4.10 to either its internal memory or to a location on the network. if the location of the sound file was known then the wireless device would retrieve the sound file 4.6, process the sound file, and play the sound file. The wireless device would then send an update message to either its internal memory or to a location on the network.

It will be understood that the invention is not restricted to the illustrated embodiments and that various modifications can be made within the scope of the following claims.

What is claimed is:

1. The method of utilizing an audio output device mounted into a wireless local area networking device to allow sounds to be played indicating the status or location of the wireless device.

2. The method of claim 1 where an electronically encoded file can be sent to the device to be played by the audio output device

3. The method of claim 2 where the content of the file is primarily to assist in locating the device

4. The method of claim 1 where the wireless device stores an electronic file locally on the wireless device to be played should the wireless device detects a corresponding stimulus or event

5. The method of claim 1 where the wireless device stores multiple electronic files locally on the wireless device to be played in the event the wireless device detects corresponding stimuli or events.

6. The method of claim 1 where the electronic files are stored on the network to be retrieved by the wireless device and played when the wireless device detects a stimuli or events.

7. An apparatus consisting of at least
a wireless networking device
a device to create an audio signal capable of producing an output frequency within the human range of hearing
an electronic file encoded in the format to allow the generation of a sound
a stimulus to trigger the wireless device to play the electronic file and generate the sound

8. The apparatus of claim 7 where the electronic file is generated by the user in real time and transmitted to the wireless device for output.

9. The apparatus of claim 7 where the user sends a trigger to the wireless device to cause it to play the electronic file via the speaker.

10. The apparatus of claim 7 where the sound generated by the device is primarily intended to assist in locating the device.

11. The apparatus of claim 7 where the sound generated by the device is designed to correspond to the status of the device.

12. An apparatus consisting of
A networking device
A first wireless channel to enable communications with end user devices
A second wireless channel utilized to backhaul signals to the wired network
An electronically encoded message representing a sound or tone
A method of converting the electronically encoded message into audible sounds detectable by a human

13. The apparatus of claim 12 where the networking device is programmed to play the electronically encoded message in the event of a stimulus.

14. The apparatus of claim 12 where the networking device plays the electronically encoded message in response to a message received over the second wireless channel

15. The apparatus of claim 12 where the networking device plays the electronically encoded message in response to a message received over the first wireless channel.

16. An apparatus consisting of
a wireless networking device
a display to visually convey textual information
logic in the device to determine appropriate textual information to display

17. The apparatus of claim 16 where the display was located on the bottom of the device in order to allow the viewing of the display on a wireless networking device that is mounted on the ceiling or high in the environment.

18. The apparatus of claim 16 where a query message is used by the wireless device to determine the proper textual information to display.

19. The apparatus of claim 16 where the display presents at least an identifier uniquely associated with the wireless device.

20. The apparatus of claim 16 where the display a differing message when the wireless device determines an abnormal function.
